(19) United States
(12) Patent Application Publication
(10) Pub. No.: US 2003/0236750 A1
(43) Pub. Date: Dec. 25, 2003

(54) Customized information access

(76) Inventors: Henri Jacques Suermondt, Sunnyvale, CA (US); Umeshwar Dayal, Saratoga, CA (US)

Correspondence Address: HEWLETT-PACKARD COMPANY, Intellectual Property Administration, P.O. Box 272400, Fort Collins, CO, 80527-2400, US

(21) Appl. No.: 10/175,469

(22) Filed: Jun. 19, 2002

(51) Int. Cl. G06F 17/60; H04K 1/00

(52) U.S. Cl. 705/50

(57) ABSTRACT

Techniques for customized access to documents and related information include an information access provider that generates a customized list that specifies which of a set of items of information related to a document are available to a consumer. The access provider provides a package containing the items selected by the consumer in response to a satisfaction of a set of conditions which are customized to the consumer.

### BACKGROUND OF THE INVENTION

1. Field of Invention

The present invention pertains to the field of information systems. More particularly, this invention relates to customized information access.

2. Art Background

An information system may provide access to a wide variety of expressions. Examples of expressions which may be provided via an information system include works of art including literature, movies, music as well as multi-media expressions, scientific publications, manuals, technical specifications, etc. These expressions are usually protect-able under intellectual property laws including copyright. Any expression which may be the subject of such legal protection is hereinafter referred to as a document.

In addition, an information system may provide access to information related to a document. Examples of information related to a document include portions of the document, condensations of the document, descriptions of the document, criticisms of the document, derivative works from the document, etc.

For example, publications are commonly available which are based on the play Hamlet by William Shakespeare. Such a publication may include the play Hamlet (the document) along with a detailed introduction, footnotes explaining many nuances of the text, commentary, etc. (the related information). Additional related information for Hamlet may include secondary literature published in other documents such as summaries or condensation of the play.

It may be desirable to provide customized access to a document and its related information. For example, access to some related information for a document may be made available for a negotiated fee or other condition while access to other related information for the document may be restricted based on a variety of criteria. In prior information systems, related information is usually packaged in some form that hinders such customized access.

### SUMMARY OF THE INVENTION

Techniques for customized access to documents and related information are disclosed which may be implemented in information systems and/or business/commerce systems. An information access provider according to the present teachings generates a customized list that specifies which of a set of items of information related to a document are available to a consumer. The access provider provides a package containing the items selected by the consumer in response to a satisfaction of a set of conditions which are customized to the consumer.

A system according to the present techniques enables the sale of information related to documents in any desired granularity. In addition, the present techniques enable sellers to provide access to information related to documents in a manner which is time-dependent. The present teachings include mechanisms that make unauthorized redistribution of purchased information more difficult. In addition, incremental purchases of the information may be made without requiring additional information or real-time access to the seller.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows an information system that incorporates the present teachings;

FIG. 2 shows a method for providing customized access to a set of items according to the present teachings;

FIG. 3 shows a method by which a consumer may purchase additional items after a previous purchase.

### DETAILED DESCRIPTION

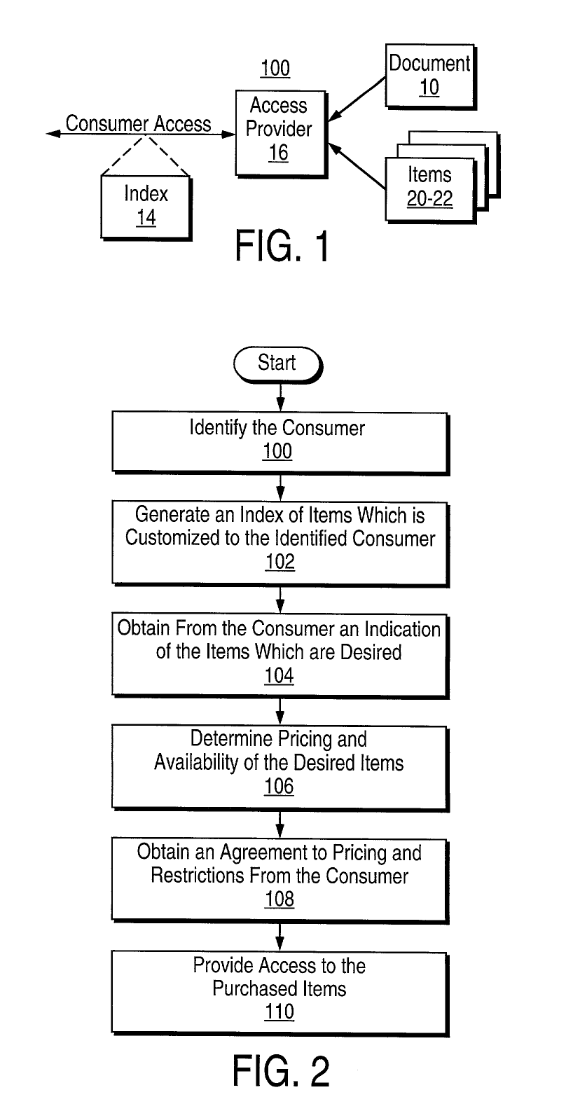

FIG. 1 shows a system 100 that incorporates the present teachings. The system 100 may be an information system and/or business/commerce system. The system 100 includes a document 10 and a set of items 20-22. The system 100 includes an access provider 16 that provides consumers with access to the items 20-22. In one embodiment, the access provider 16 acts as an agent of one or more sellers associated with the items 20-22.

A The document 10 represents any expression which may be subject to intellectual property protection including copyright protection. Examples for the document 10 include printed publications, for example literary and scientific publications, etc., as well as music, movies, video, multimedia, software, games, etc.

Each of the items 20-22 is information related to the document 10. The items 20-22 may include derivative or related works. For example, if the document 10 is a novel then one of the items 20-22 may be a movie version of the novel or a condensed version of the novel or a play based on the novel. As another example, if the document 10 is a movie then one of the items 20-22 may be a soundtrack of the movie or a movie sequel or a book based on the movie, etc. For the purposes of the present methods of customized access, the document 10 may be treated as an item of information related to itself and may be packaged and provided to a consumer.

The items 20-22 may include other types of information related to the document 10. One example of related information is a probabilistic location of the document 10 in a topic hierarchy or ontology. Another example of related information is the relationships of the document 10 with other documents or information. Another example of related information is a sub-portion of the document 10—for example chapters of a publication or tracks of an audio recording or episodes of a serial drama. Another example of related information is a summary of the document 10 or a criticism of the document 10.

The items 20-22 may include cataloging information such as a title, a creation date, a list of authors for the document 10. The items 20-22 may include an indication of the most recent version of the document 10, or a hash key to verify the integrity of the document 10. The items 20-22 may include information that describes the content of the document 10—for example a list of keywords in the document 10 or an abstract for the document 10.

The system 100 may include mechanisms for packaging and distributing the items 20-22 via one or more of a variety of available distribution media including print form, electronic form including files distributed via networks including the Internet, compact discs, DVDs, magnetic tapes, video tapes, etc.

The system 100 may be embodied as an automated computer-based system in which the items 20-22 are stored electronically and provided electronically to consumers via communication channels such as network connections or portable storage output forms. Alternatively, the system 100 may be embodied in a business process that may or may not include automation. The items 20-22 need not be stored but may be generated as needed.

The system 100 provides customized access to the document 10 and its items 20-22. The system 100 dynamically releases individual ones of the items 2022 based on the results of negotiations between a provider of the document 10 and the items 20-22 and a consumer. The system 100 enables different types of the items 20-22 to be treated differently—for example to be sold at different levels of price. The system 100 in some embodiments provides automated classifications of the document 10 and the items 20-22 and automatically determines relationships with other documents.

The system 100 in one embodiment represents the items 20-22 as a set of identifier-content pairs. The identifier-content pairs are referred to as (I₁, C₁) . . . (Iₙ, Cₙ). The identifiers I₁,. . . Iₙ may take any form. For example, if the document 10 is a novel then the identifier I₁ may be a part number or a text description of a movie which is based on the novel. The content C₁ in that example would be that movie in some form such as MPEG etc.

The identifier-content pairs (I₁, C₁) . . . (Iₙ, Cₙ) may be obtained in any manner. For example, a variety of techniques exist for automatically classifying a document in a topic hierarchy. Other techniques exist for deriving other forms of information pertaining to a document.

The access provider 16 generates an index 14 that provides a consumer with customized access to the items 20-22. The index 14 includes a list of the items 20-22 which are available to a consumer. The index 14 provides the identifiers {I₁, . . . Iₙ} of the items 20-22 which are available to the consumer. The identifiers {I₁, . . . . Iₙ} may be organized in any manner including a hierarchy or a some other form of composition. For example, the identifier I₃ may consist of the identifiers I₁₁, . . . I₁₂.

In some embodiments, the index 14 is annotated in a manner which enables customized access to a consumer. For example, the index 14 may include information that specifies each identifier, how each identifier may be used, who the target audience may be for each identifier, and other information that may be used to decide whether a particular identifier may be of interest to a consumer.

Different owners, i.e. right-holders, may be associated with different identifier-content pairs (I₁, C₁) . . . (Iₙ, Cₙ). Alternatively, all identifier-content pairs (I₁, C₁) . . . (Iₙ, Cₙ) may be associated with the same owner. The access provider 16 may function as an agent that represents all owners of the identifier-content pairs (I₁, C₁) . . . (Iₙ, Cₙ) and act as a seller.

For example, an owner of one identifier-content pair (I₁, Cᵢ) may specify the following for that pair. The owner may specify an identification and/or characterization of the consumers that are allowed to discover/view the identifier Iᵢ. This identification and/or characterization may also apply to a description associated with the identifier Iᵢ. For example, some consumers may not be allowed to know the identifier Iᵢ even exists. This identification and/or characterization may include categories of consumers—for example “anyone,” “project managers,” “members of an organization,” etc. The owner may specify an identification and/or characterization of consumers that have the ability to purchase Cᵢ. The owner may specify a pricing model for purchasing Cᵢ. For example, discounts or price increases may be specified depending on what other identifier-content pairs (I₁, C₁) . . . (Iₙ, Cₙ) have been purchased and/or depending on an identification and/or characterization of the consumers, etc. The pricing model may include day prices, etc.

FIG. 2 shows a method for providing customized access to the items 20-22 according to the present teachings. At step 100, a consumer of the items 20-22 is identified. The identification at step 100 may be performed in a known manner. For example passwords and/or electronic/mechanical identification mechanisms may be employed. The identification at step 100 may be verified using any known security mechanism. At step 100, an option may be provided for the consumer to remain anonymous or provide only proof of partial information—for example “Organization A project manager.”

At step 102, the index 14 is generated so that it is customized to the consumer identified at step 100. The index 14 is provided to the consumer identified at step 100. The index 14 contains only information that the consumer identified at step 100 is authorized to view/discover based on the information provided during identification at step 100. In some embodiments, limits may be placed on the amount of time during which the index 14 is valid.

The index 14 may be customized in ways to limit its use to the identified consumer using a security mechanism. For example, the identified consumer may not be allowed to pass on the index 14 to someone else. The index 14 may include price information. Alternatively, the pricing information may be deferred to a later step.

At step 104, an indication is obtained of which of the items 20-22 listed in the index 14 are desired by the consumer. In response to this indication, one or more identifiers (I₁, . . . Iₙ) from the index 14 are selected for pricing. Alternatively, the pricing may fixed and made available with the index 14.

At step 106, the pricing of the desired items 20-22 is determined by the seller and availability of the corresponding identifier-content pairs (I₁, C₁) . . . (Iₙ, Cₙ) is verified by the seller. The seller commits to selling the identifier-content pairs (I₁, C₁) . . . (Iₙ, Cₙ) at the specified pricing and possibly for a limited amount of time. Step 106 may be skipped if the pricing is fixed and made available with the index 14.

At step 108, an agreement is obtained from the consumer to the pricing and possibly one or more restrictions on the purchase. One example of a restriction is a time expiration of access to the selected identifier-content pairs (I₁, . . . (Iₙ, Cₙ). Another example of a restriction is not being allowed to copy or to redistribute the selected identifier-content pairs (I₁, C₁) . . . (Iₙ, Cₙ) Otherwise, the identified consumer declines or the transaction times out at step 108.

At step 110, the seller provides access to the purchased items 20-22, i.e. to the identifier-content pairs (I₁, C₁) . . . (Iₙ, Cₙ) for which the identifiers were selected at step 104. The access provided at step 110 is consumer-specific and may require satisfaction of one or more conditions such as proof of identity or alternatively of membership in the category under which the purchased was made. The access may be conditional on owning access to the document 10 to which the items 20-22 relate. The access may be for a limited amount of time.

In one embodiment, the complete set of identifier-content pairs (I₁, C₁) . . . (Iₙ, Cₙ) is encrypted such that each pair is encrypted using a separate key. All possible, i.e. purchasable, combinations of identifier-content pairs (I₁, C₁) . . . (Iₙ, Cₙ) are encrypted independently. The whole is aggregated such that it forms one package as the items 20-22. The access provider 16 obtains the items 20-22 in this encrypted form and a token such as a decryption key that provides proof of the identity of the consumer. The access provider 16 releases the appropriate identifier-content pairs in response to the token without allowing access to other information that may be in the remaining identifier-content pairs but to which the consumer has not qualified for access. The access provider 16 may employ standard decryption mechanisms to obtain the package form of the items 20-22. The access provider 16 may obtain a token of proof of the consumers identity as well as other required information. The other required information from the consumer may include a proof of time-dependent validity such as a decryption key which is time-stamped.

A single top-level consumer-specific key may be employed in this embodiment. The consumer-specific key may decode into a set of all the sub-keys needed to decode each of the identifier-content pairs (I₁, C₁) . . . (Iₙ, Cₙ) purchased. The access provider 16 is given the key and then determines which identifier-content pairs (I₁, C₁) . . . (Iₙ, Cₙ) are to be decoded so that the consumer does not have to specify the details.

The identifier-content pairs (I₁, C₁) . . . (Iₙ, Cₙ) that are released to a consumer may be “watermarked,” i.e., annotated in a manner that does not hamper its authorized use by the consumer, thereby allowing a seller to verify that access by a consumer is authorized. This aids in preventing unauthorized redistribution by a consumer once access is obtained and enables a seller to trace the source of unauthorized copies.

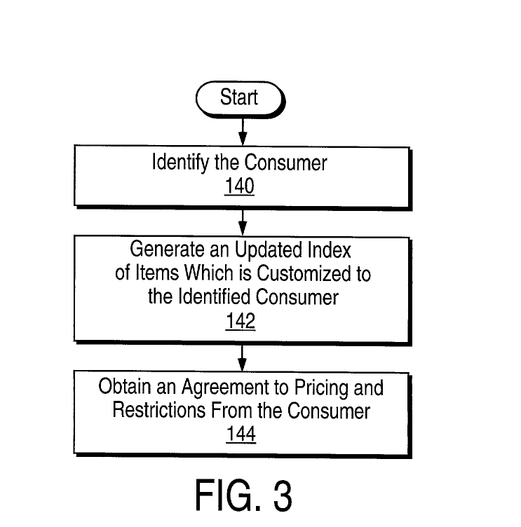

FIG. 3 shows a method by which a consumer may purchase additional identifier-content pairs (I₁, C₁) . . . (Iₙ, Cₙ) after a previous purchase. At step 140, the consumer is identified. Step 140 may include the consumer providing to the access provider 16 a proof of a previous purchase such as a key obtained by the consumer as a result of the previous purchase.

At step 142, an update of the index 14 is generated and provided to the consumer. The updated index 14 shows the remaining identifiers Iᵢ which are available to the consumer identified at step 140. Pricing information, if appropriate, and other information may be updated in the index 14 to reflect the new circumstances such as a previous purchase, time passed, and other conditions. The update to the index 14 may also include references to updates regarding previously purchased identifiers. As before, the consumer provides an indication of which of the identifier-content pairs (I₁, C₁) . . . (Iₙ, Cₙ) listed in the updated index 14 are desired and then the pricing of the newly desired identifier-content pairs (I₁, C₁) . . . (Iₙ, Cₙ) is determined by the seller and their availability is verified by the seller.

At step 144, an agreement is then obtained from the consumer to the pricing and possibly one or more restrictions on the purchase of the additional identifier-content pairs (I₁, C₁) . . . (Iₙ, Cₙ). The seller can delegate authority to make this commitment to the access provider 16.

If the identifier-content pairs (I₁, C₁) . . . (Iₙ, Cₙ) were already part of the original package which the consumer has already has in encrypted form, then the consumer is provided with an updated key that enables access to the enlarged set. Payment is sent to the seller.

If the newly purchased information is not entirely included in the package, for example if new identifier-content pairs (I₁, C₁) (Iₙ, Cₙ) have become available since it was provided, a new package that supercedes or supplements the previous one is provided along with a key that provides access. The new key may supercede or supplement the previous key in providing access.

In one embodiment, the document 10 and the items 20-22 are encoded jointly as a single document in a mark-up language such as XML. The access provider 16 is embodied as software that takes the XML document as well as an access token that proves an access privilege of a consumer, and transforms the XML document into a version that contains only the information the consumer is allowed to see. This transformed version is then released to the consumer.

In some embodiments, a portion of the items 20-22 is provided as an inexpensive (possibly free) “teaser” to allow consumers to decide whether the document 10 may be of value. For example, a technological analysis may be encoded to inexpensively describe a technology at a very high level while selling the details at its appropriate value.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A system including an access provider that generates a customized list that specifies which of a set of items of information related to a document are available to a consumer in response to an identification of the consumer.

2. The system of claim 1, wherein the access provider provides a package containing the items selected by the consumer in response to a satisfaction of a set of conditions which are customized to the consumer.

3. The system of claim 2, wherein the conditions include a set of pricing information associated with the items.

4. The system of claim 3, wherein the pricing information depends on the identification of the consumer.

5. The system of claim 3, wherein the pricing information is included in the customized list.

6. The system of claim 2, wherein the conditions include an organizational membership provided with the identification.

7. The system of claim 6, wherein the conditions include a set of pricing information which depends on the organizational membership.

8. The system of claim 2, wherein the package is associated with a set of restrictions pertaining to the items in the package.

9. The system of claim 8, wherein the restrictions depend on the identification of the consumer.

10. The system of claim 2, wherein the package is encrypted.

11. A method for customized information access, comprising the steps of:
obtaining an identification of a consumer;
generating a list of items of information related to a document which are available to the consumer in response to the identification.

12. The method of claim 11, further comprising the step of obtaining an indication from the consumer of one or more of the items which are desired.

13. The method of claim 12, further comprising the step of determining a pricing of the items which are desired.

14. The method of claim 13, wherein the step of determining a pricing comprises the step of determining the pricing in response to the identification.

15. The method of claim 12, further comprising the step of determining an availability of the items which are desired.

16. The method of claim 12, further comprising the step of providing the consumer with access to the items which are desired.

17. The method of claim 16, wherein the step of providing the consumer with access to the items which are desired comprises the step of providing the consumer with access for a limited amount of time.

18. The method of claim 16, the step of providing the consumer with access comprises the step providing the consumer with a key for decrypting the items which are desired.

19. The method of claim 11, wherein the step of generating a list of items which are available to the consumer comprises the step of generating the list in response to an organizational membership pertaining to the consumer.

20. The method of claim 11, further comprising the step of generating an update of the list in response to a previous purchase by the consumer.
